(19) United States
(12) Patent Application Publication
(10) Pub. No.: US 2026/0106064 A1
(43) Pub. Date: Apr. 16, 2026

(54) Electro Magnetic Joint Device

(71) Applicant: Matthew Shun, Glendale, CA (US)

(72) Inventor: Matthew Shun, Glendale, CA (US)

(21) Appl. No.: 19/018,148

(22) Filed: Jan. 13, 2025

Related U.S. Application Data
(60) Provisional application No. 63/707,963, filed on Oct. 16, 2024.

(51) Int. Cl. H01F 7/08; B25J 9/14

(52) U.S. Cl. CPC H01F 7/081; B25J 9/14

(57) ABSTRACT

An electromagnetic joint device, which is a machinery or robotic equipment system that uses electromagnets to control machinery joints with electric power instead of hydraulic operated pistons. The electromagnetic joint device comprises a robotic knee or elbow joint design but without hydraulic pistons providing the movement. The joint device comprises an axle with electromagnets arranged around it with connected electric wires changing the north-south orientation of each magnet's magnetic field. The arm has similar electromagnets, and the magnetic field is made to attract or repel the magnets between the axle and the arm causing the movement between arm and axle. To prevent the axle and arm slipping once in position, a solenoid actuated steel pin housed in the axle must be energized to engage a circular hole in the arm of the assembly.

### CROSS-REFERENCE TO RELATED APPLICATION

The present application claims priority to, and the benefit of, U.S. Provisional Application No. 63/707,963, which was filed on Oct. 16, 2024, and is incorporated herein by reference in its entirety.

### FIELD OF THE INVENTION

The present invention relates generally to the field of electromagnetic joint devices. More specifically, the present invention relates to a plurality of electromagnets designed to control machinery joints in place of hydraulic operated pistons. Accordingly, this disclosure makes specific reference thereto the present invention. Nonetheless, it is to be appreciated that aspects of the present invention are also equally applicable to other like applications, devices and methods of manufacture.

### BACKGROUND

By way of background, this invention relates to improvements in electromagnetic joint devices. Generally, standard mechanical equipment is typically equipped with hydraulic systems that facilitate movement. While hydraulic systems are useful, they require specialized maintenance due to potential hydraulic fluid leaks. Further, those trained in maintaining the hydraulic systems may not always be available to fix the system when broken.

Additionally, these hydraulic systems are bulky and may not accommodate smaller spaces. Further, the bulk of the hydraulic systems tend to add weight to equipment that makes it hard to transport.

Accordingly, there is a demand for an improved electromagnetic joint device that allows users to control machinery joints in place of hydraulic operated pistons. More particularly, there is a demand for an electromagnetic joint device that features electromagnets arranged around the axle and arm to facilitate movement.

Therefore, there exists a long felt need in the art for an electromagnetic joint device that provides users with electromagnets designed to control machinery joints in place of hydraulic operated pistons. There is also a long felt need in the art for an electromagnetic joint device that features electromagnets arranged around the axle and on the arm in which both sets of magnets attract or repel the magnets between the axle and arm to facilitate movement. Further, there is a long felt need in the art for an electromagnetic joint device that reduces and eliminates hydraulic system maintenance, saving extensive time and money. Moreover, there is a long felt need in the art for a device that functions as a replacement for hydraulics in any type of mechanical equipment and robots. Further, there is a long felt need in the art for an electromagnetic joint device that can be secured with a solenoid actuated steel pin. Finally, there is a long felt need in the art for an electromagnetic joint device that uses the solenoid to prevent the axle and arm from slipping once in position.

The subject matter disclosed and claimed herein, in one embodiment thereof, comprises an electromagnetic joint device. The device is a machinery or robotic equipment system that uses electromagnets to control machinery joints with electric power instead of hydraulic operated pistons. The electromagnetic joint device comprises a robotic knee, elbow or finger joint design but without hydraulic pistons providing the movement. The joint device comprises an axle with electromagnets arranged around it with connected electric wires changing the north-south orientation of each magnet's magnetic field. The arm has similar electromagnets, and the magnetic field is made to attract or repel the magnets between the axle and the arm causing the movement between arm and axle. To prevent the axle and arm slipping once in position, a solenoid actuated steel pin housed in the axle must be energized to engage a circular hole in the arm of the assembly. More than one of these solenoid pins may be necessary. Further, device can be constructed using stainless steel, plastic, and other suitable materials.

In this manner, the electromagnetic joint device of the present invention accomplishes all of the forgoing objectives and provides users with electromagnets designed to control machinery joints. The joint is a robotic knee or elbow joint design. The device utilizes solenoids to secure the joint.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an electromagnetic joint device. The electromagnetic joint device comprises a robotic knee, elbow or finger joint design but without hydraulic pistons providing the movement. The joint device comprises an axle and arms with electromagnets arranged around it with connected electric wires changing the north-south orientation of each magnet's magnetic field. The magnetic field is made to attract or repel the magnets between the axle and the arm causing the movement between arm and axle.

In one embodiment, the electromagnetic joint device provides users with electromagnets designed to control machinery joints in place of hydraulic operated pistons. The device reduces and eliminates hydraulic system maintenance, saving extensive time and money. The device functions as a replacement for hydraulics in any type of mechanical equipment and robots.

In one embodiment, the electromagnetic joint device comprises a typical pin joint or other suitable machinery joints as is known in the art, such as any joint that provides a mechanical connection that allows relative rotation between connected components while restricting translational movement. The device allows electromagnets to control the machinery joints with electric power instead of hydraulic operated pistons.

In one embodiment, the electromagnetic joint device comprises a pair of arms connected by an axle, creating the pin joint. The arms can be any suitable size and shape as is known in the art, and depending on the joint, are available in multiple sizes and shapes. Typically, two arms are utilized with the pin joint. In this disclosure, each arm is configured in a rectangular shape and comprises a top surface, a bottom surface, opposing sidewalls, and opposing ends.

In one embodiment, the ends of two arms are connected together by an axle. The axle allows the two arms to rotate and move the joint. The axle can be any suitable axle as is known in the art. Depending on the sizes of the arms, the axle can also be available in multiple sizes.

In one embodiment, the ends of the two arms which connect together comprise a plurality of electromagnets arranged in an arch-like configuration. The plurality of electromagnets are connected together via electric wires and other circuitry, which is then in communication with a battery (of specific voltage for the joint) and a controller of the device to control the magnetic field of the electromagnets. The battery powers the device and the controller allows for changing the magnetic poles (i.e., polarity), as needed. Specifically, the north-south orientation of each magnet's magnetic field can be changed.

In one embodiment, the axle comprises a plurality of electromagnets arranged in an arch-like configuration. The arch-like configuration of electromagnets are positioned inside the arch-like configuration of electromagnets on the arms. Both sets of electromagnets are positioned in concentric arches. The plurality of electromagnets are connected together via electric wires and other circuitry, which is then in communication with the battery (of specific voltage for the joint) and the controller of the device to control the magnetic field of the electromagnets. The battery powers the device and the controller allows for changing the magnetic poles, as needed. Specifically, the north-south orientation of each magnet's magnetic field can be changed.

In one embodiment, the plurality of magnets, may be made of neodymium or other suitable magnetic material, and may be secured to the arms and axle with appropriate adhesives or other suitable retaining structures as is known in the art.

In one embodiment, the controller of the device acts to change the polarity of the electromagnets. When the electromagnets of the arms and axle are of opposite poles, they attract each other. When the electromagnets of the arms and axle are of like poles, they are repelled from each other. Thus, in order to move the joint, the controller must change the magnetic charges of the electromagnets to like poles, causing the electromagnets to repel each other. Further, the controller acts to time the changing of the magnetic charges, such that one electromagnet after another is changed to a specific magnetic charge, until the joint is moved the determined distance/position.

In one embodiment, once the joint is moved in position, the joint can be locked into place via a solenoid actuated steel pin. The solenoid actuated steel pin is housed in the axle and must be energized to engage a circular through-hole in the arm of the device. The solenoid and other circuitry connect to the battery and controller of the device to control the solenoid, as needed. In this embodiment, the device would keep the electricity on to continue to charge the device and prevent the joint from slipping and the solenoid from failing. In another embodiment, the solenoid can be kept in an extended position, such that it contacts the circular through-hole in a normal/off position, and then when energized, the pin is retracted from the circular through-hole. Thus, in this embodiment, the device does not need to be constantly powered to retain the joint in place. The joint can be moved via the electromagnets and then locked in place with the solenoid, and once in place, the power can be removed and the solenoid remains in an extended position, keeping the joint in place.

In one embodiment, more than one of the solenoid actuated steel pins may be necessary. Thus, in this embodiment, multiple solenoids can be utilized to prevent the joint from slipping.

In one embodiment, the electromagnetic joint device is manufactured of any suitable non-ferrous metal or polymer/plastic materials as is known in the art, or combinations thereof.

In yet another embodiment, the electromagnetic joint device comprises a plurality of indicia.

In yet another embodiment, a method of controlling machinery joints using electromagnets is disclosed. The method includes the steps of providing an electromagnetic joint device comprising an axle and an arm of a joint which are surrounded by magnets. The method also comprises positioning the electromagnets arranged around the axle. Further, the method comprises positioning the electromagnets arranged around the arm. The method also comprises charging the magnetic field to attract or repel the magnets between the axle and the arm. The method also comprises moving the arm and axle due to attraction of the electromagnets. Finally, the method comprises locking the joint device in position via a solenoid actuated steel pin which engages a through hole.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the electromagnetic joint device of the present invention in accordance with the disclosed architecture;

FIG. 2 illustrates a perspective view of one embodiment of the electromagnetic joint device of the present invention showing the magnets in use with the joint in accordance with the disclosed architecture;

FIG. 3 illustrates a perspective view of one embodiment of the electromagnetic joint device of the present invention showing the axle and arm of the joint in accordance with the disclosed architecture;

FIG. 4 illustrates a perspective view of one embodiment of the electromagnetic joint device of the present invention showing the solenoid actuated steel pin in use in accordance with the disclosed architecture;

FIG. 5 illustrates a perspective view of one embodiment of the electromagnetic joint device of the present invention showing the device in use in accordance with the disclosed architecture; and

FIG. 6 illustrates a flowchart showing the method of controlling machinery joints using electromagnets in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for an electromagnetic joint device that provides users with electromagnets designed to control machinery joints in place of hydraulic operated pistons. There is also a long felt need in the art for an electromagnetic joint device that features electromagnets arranged around the axle and on the arm in which both sets of magnets attract or repel the magnets between the axle and arm to facilitate movement. Further, there is a long felt need in the art for an electromagnetic joint device that reduces and eliminates hydraulic system maintenance, saving extensive time and money. Moreover, there is a long felt need in the art for a device that functions as a replacement for hydraulics in any type of mechanical equipment and robots. Further, there is a long felt need in the art for an electromagnetic joint device that can be secured with a solenoid actuated steel pin. Finally, there is a long felt need in the art for an electromagnetic joint device that uses the solenoid to prevent the axle and arm from slipping once in position.

The present invention, in one exemplary embodiment, is a novel electromagnetic joint device. The electromagnetic joint device comprises a robotic knee or elbow joint design but without hydraulic pistons providing the movement. The joint device comprises an axle with electromagnets arranged around it with connected electric wires changing the north-south orientation of each magnet's magnetic field. The arm has similar electromagnets, and the magnetic field is made to attract or repel the magnets between the axle and the arm causing the movement between arm and axle. To prevent the axle and arm slipping once in position, a solenoid actuated steel pin housed in the axle must be energized to engage a circular hole in the arm of the assembly. The present invention also includes a novel method of controlling machinery joints using electromagnets. The method includes the steps of providing an electromagnetic joint device comprising an axle and an arm of a joint which are surrounded by magnets. The method also comprises positioning the electromagnets arranged around the axle. Further, the method comprises positioning the electromagnets arranged around the arm. The method also comprises charging the magnetic field to attract or repel the magnets between the axle and the arm. The method also comprises moving the arm and axle due to attraction of the electromagnets. Finally, the method comprises locking the joint device in position via a solenoid actuated steel pin which engages a through hole.

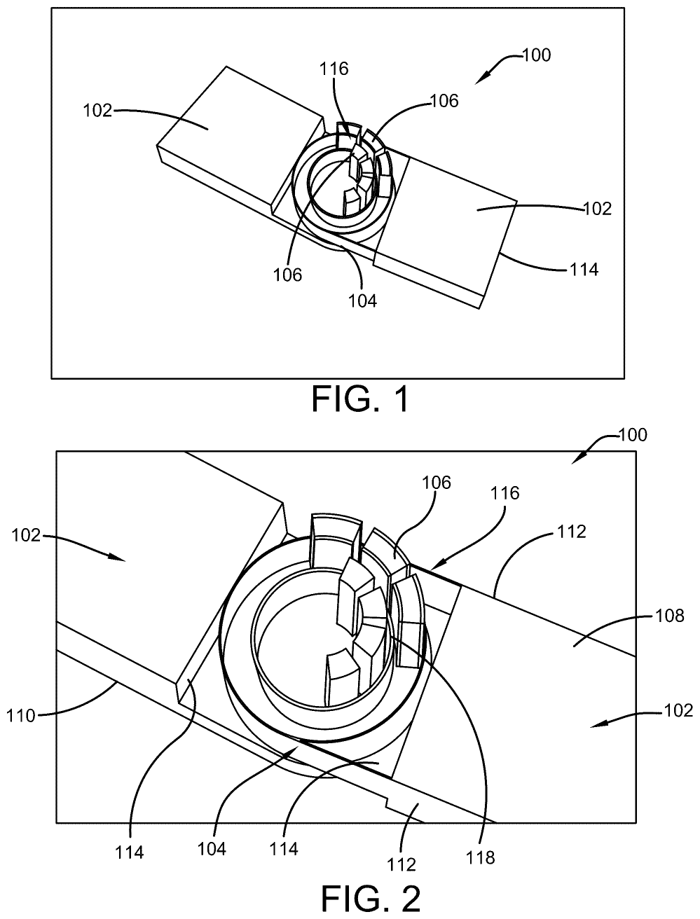

Referring initially to the drawings, FIG. 1 illustrates a perspective view of one embodiment of the electromagnetic joint device 100 of the present invention. In the present embodiment, the electromagnetic joint device 100 is an improved electromagnetic joint device 100 that provides a user with machinery joints controlled by electromagnets. Specifically, the electromagnetic joint device 100 comprises an arm 102 and an axle 104 with electromagnets 106 arranged around them. The magnetic fields of the magnets 106 are made to attract or repel, causing the movement between arm 102 and axle 104.

Generally, the electromagnetic joint device 100 provides users with electromagnets 106 designed to control machinery joints in place of hydraulic operated pistons. The device 100 reduces and eliminates hydraulic system maintenance, saving extensive time and money. The device 100 functions as a replacement for hydraulics in any type of mechanical equipment and robots.

Further, the electromagnetic joint device 100 comprises a typical pin joint 116 or other suitable machinery joints as is known in the art, such as any joint that provides a mechanical connection that allows relative rotation between connected components while restricting translational movement. The device 100 allows electromagnets 106 to control the machinery joints with electric power instead of hydraulic operated pistons.

Additionally, the electromagnetic joint device 100 comprises a pair of arms 102 connected by an axle 104, creating the pin joint 116. The arms 102 can be any suitable size and shape as is known in the art, and depending on the joint 116, are available in multiple sizes and shapes. Typically, two arms 102 are utilized with the pin joint 116. In this disclosure, each arm 102 is configured in a rectangular shape and comprises a top surface 108, a bottom surface 110, opposing sidewalls 112, and opposing ends 114.

Further, the ends 114 of two arms 102 are connected together by an axle 104. The axle 104 allows the two arms 102 to rotate and move the joint 116. The axle 104 can be any suitable axle as is known in the art. Depending on the sizes of the arms 102, the axle 104 can also be available in multiple sizes.

Furthermore, the ends 114 of the two arms 102 which connect together comprise a plurality of electromagnets 106 arranged in an arch-like configuration. The plurality of electromagnets 106 are connected together via electric wires 118 and other circuitry, which is then in communication with a battery 120 (of specific voltage for the joint 116) and a controller 122 of the device 100 to control the magnetic field of the electromagnets 106. The battery 120 powers the device 100 and the controller 122 allows for changing the magnetic poles (i.e., polarity), as needed. Specifically, the north-south orientation of each magnet's magnetic field can be changed.

As shown in FIG. 2, the axle 104 comprises a plurality of electromagnets 106 arranged in an arch-like configuration. The arch-like configuration of electromagnets 106 are positioned inside the arch-like configuration of electromagnets 106 on the arms 102. Both sets of electromagnets 106 are positioned in concentric arches. The plurality of electromagnets 106 are connected together via electric wires 118 and other circuitry, which is then in communication with the battery 120 (of specific voltage for the joint 116) and the controller 122 of the device 100 to control the magnetic field of the electromagnets 106. The battery 120 powers the device 100 and the controller 122 allows for changing the magnetic poles, as needed. Specifically, the north-south orientation of each magnet's magnetic field can be changed.

Further, the plurality of magnets 106, may be made of neodymium or other suitable magnetic material, and may be secured to the arms 102 and axle 104 with appropriate adhesives or other suitable retaining structures as is known in the art.

Additionally, the controller 122 of the device 100 acts to change the polarity of the electromagnets 106. When the electromagnets 106 of the arms 102 and axle 104 are of opposite poles, they attract each other. When the electromagnets 106 of the arms 102 and axle 104 are of like poles, they are repelled from each other. Thus, in order to move the joint 116, the controller 122 must change the magnetic charges of the electromagnets 106 to like poles, causing the electromagnets 106 to repel each other. Further, the controller 122 acts to time the changing of the magnetic charges, such that one electromagnet 106 after another is changed to a specific magnetic charge, until the joint 116 is moved the determined distance/position.

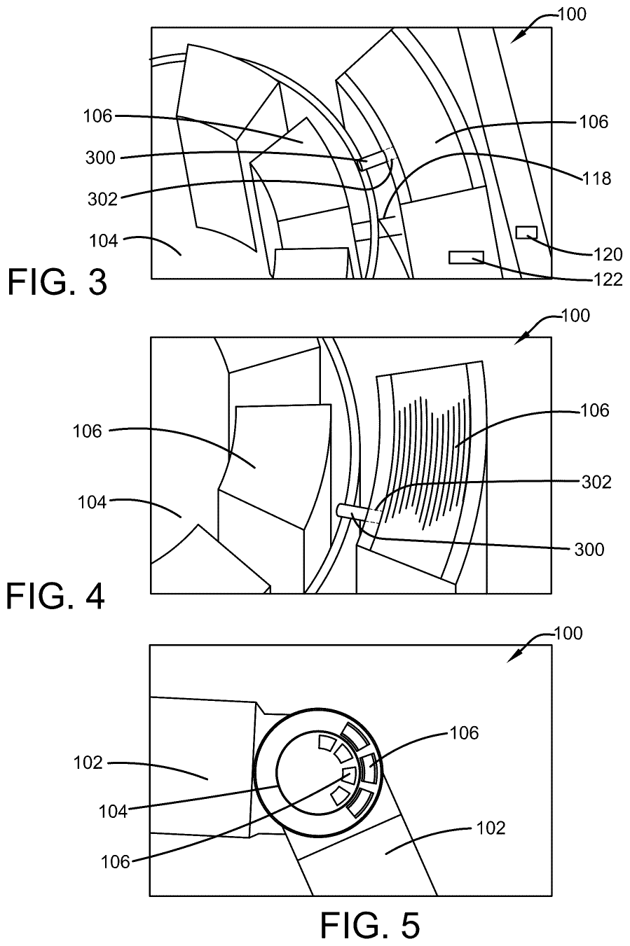

As shown in FIGS. 3-4, once the joint 116 is moved in position, the joint 116 can be locked into place via a solenoid actuated steel pin 300. The solenoid actuated steel pin 300 is housed in the axle 104 and must be energized to engage a circular through-hole 302 in the arm 102 of the device 100. The solenoid 300 and other circuitry connect to the battery 120 and controller 122 of the device 100 to control the solenoid 300, as needed. In this embodiment, the device 100 would keep the electricity on to continue to charge the device 100 and prevent the joint 116 from slipping and the solenoid 300 from failing. In another embodiment, the solenoid 300 can be kept in an extended position, such that it contacts the circular through-hole 302 in a normal/off position, and then when energized, the pin is retracted from the circular through-hole 302. Thus, in this embodiment, the device 100 does not need to be constantly powered to retain the joint 116 in place. The joint 116 can be moved via the electromagnets 106 and then locked in place with the solenoid 300, and once in place, the power can be removed and the solenoid 300 remains in an extended position, keeping the joint 116 in place.

In one embodiment, more than one of the solenoid actuated steel pins 300 may be necessary. Thus, in this embodiment, multiple solenoids 300 can be utilized to prevent the joint 116 from slipping.

As shown in FIG. 5, the electromagnetic joint device 100 is manufactured of any suitable non-ferrous metal or polymer/plastic materials as is known in the art, or combinations thereof.

In yet another embodiment, the electromagnetic joint device 100 comprises a plurality of indicia 500. The arm 102 of the device 100 may include advertising, a trademark, or other letters, designs, or characters, printed, painted, stamped, or integrated into the arm 102, or any other indicia 500 as is known in the art. Specifically, any suitable indicia 500 as is known in the art can be included, such as but not limited to, patterns, logos, emblems, images, symbols, designs, letters, words, characters, animals, advertisements, brands, etc., that may or may not be joint, magnets, or brand related.

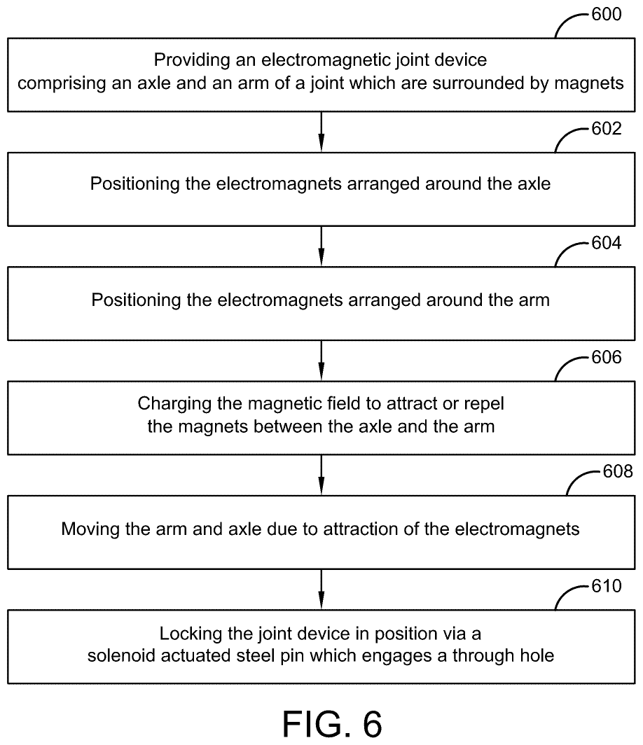

FIG. 6 illustrates a flowchart of the method of controlling machinery joints using electromagnets. The method includes the steps of at 600, providing an electromagnetic joint device comprising an axle and an arm of a joint which are surrounded by magnets. The method also comprises at 602, positioning the electromagnets arranged around the axle. Further, the method comprises at 604, positioning the electromagnets arranged around the arm. The method also comprises at 606, charging the magnetic field to attract or repel the magnets between the axle and the arm. The method also comprises at 608, moving the arm and axle due to attraction of the electromagnets. Finally, the method comprises at 610, locking the joint device in position via a solenoid actuated steel pin which engages a through hole.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “electromagnetic joint device”, “electromagnetic device”, “joint device”, and “device” are interchangeable and refer to the electromagnetic joint device 100 of the present invention.

Notwithstanding the forgoing, the electromagnetic joint device 100 of the present invention can be of any suitable size and configuration as is known in the art without affecting the overall concept of the invention, provided that it accomplishes the above stated objectives. One of ordinary skill in the art will appreciate that the electromagnetic joint device 100 as shown in FIGS. 1-6 is for illustrative purposes only, and that many other sizes and shapes of the electromagnetic joint device 100 are well within the scope of the present disclosure. Although the dimensions of the electromagnetic joint device 100 are important design parameters for user convenience, the electromagnetic joint device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An electromagnetic joint device that provides a user with a machinery joint controlled by electromagnets, the electromagnetic joint device comprising:
a pair of arms;
an axle; and
a plurality of electromagnets;
wherein the pair of arms are connected together by the axle to form a pin joint;
wherein the plurality of electromagnets are secured to the pair of arms;
wherein the plurality of electromagnets are secured to the axle; and
further wherein the plurality of electromagnets are made to attract or repel each other, causing movement between the pair of arms and the axle, and thus moving the pin joint.

2. The electromagnetic joint device of claim 1, wherein each arm is configured in a rectangular shape and comprises a top surface, a bottom surface, opposing sidewalls, and opposing ends.

3. The electromagnetic joint device of claim 2, wherein the opposing ends of the pair of arms are connected together by the axle.

4. The electromagnetic joint device of claim 3, wherein the plurality of electromagnets are arranged in an arch-like configuration on the pair of arms.

5. The electromagnetic joint device of claim 4, wherein the plurality of electromagnets are connected together via electric wires and other circuitry.

6. The electromagnetic joint device of claim 5, wherein the plurality of electromagnets are arranged in an arch-like configuration on the axle.

7. The electromagnetic joint device of claim 6, wherein the plurality of electromagnets are connected together via electric wires and other circuitry.

8. The electromagnetic joint device of claim 7, wherein both sets of electromagnets are positioned in concentric arches.

9. The electromagnetic joint device of claim 8, wherein the plurality of electromagnets are in communication with a battery.

10. The electromagnetic joint device of claim 9, wherein the plurality of electromagnets are in communication with a controller.

11. The electromagnetic joint device of claim 10, wherein the controller controls magnetic field of the plurality of electromagnets.

12. The electromagnetic joint device of claim 11, wherein once the pin joint is moved in position, the pin joint can be locked into place via a solenoid actuated steel pin.

13. An electromagnetic joint device that provides a user with a machinery joint controlled by electromagnets, the method comprising:
a pair of arms with each arm configured in a rectangular shape and comprising a top surface, a bottom surface, opposing sidewalls, and opposing ends;
an axle; and
a plurality of electromagnets which are connected together via electric wires and other circuitry;
wherein the opposing ends of the pair of arms are connected together by the axle to form a pin joint;
wherein the plurality of electromagnets are arranged in an arch-like configuration on the pair of arms;
wherein the plurality of electromagnets are arranged in an arch-like configuration on the axle;
wherein both sets of electromagnets are positioned in concentric arches;
wherein the plurality of electromagnets are in communication with a battery;
wherein the plurality of electromagnets are in communication with a controller;
wherein the controller controls magnetic field of the plurality of electromagnets; and
further wherein the plurality of electromagnets are made to attract or repel each other, causing movement between the pair of arms and the axle, and thus moving the pin joint.

14. The electromagnetic joint device of claim 13, wherein once the pin joint is moved in position, the pin joint can be locked into place via a solenoid actuated steel pin.

15. The electromagnetic joint device of claim 14, wherein the solenoid actuated steel pin is housed in the axle and must be energized to engage a circular through-hole in one of the pair of arms.

16. The electromagnetic joint device of claim 15, wherein multiple solenoid actuated steel pins are utilized to prevent the pin joint from slipping.

17. The electromagnetic joint device of claim 13, wherein the electromagnetic joint device is manufactured of non-ferrous metals or polymer materials, or combinations thereof.

18. The electromagnetic joint device of claim 13 further comprising a plurality of indicia.

19. The electromagnetic joint device of claim 13, wherein the plurality of magnets are made of neodymium.

20. A method of controlling machinery joints using electromagnets, the method comprising the following steps:
providing an electromagnetic joint device comprising an axle and an arm of a joint which are surrounded by magnets;
positioning the electromagnets arranged around the axle;
positioning the electromagnets arranged around the arm;
charging the magnetic field to attract or repel the magnets between the axle and the arm; moving the arm and axle due to attraction of the electromagnets; and
locking the joint device in position via a solenoid actuated steel pin which engages a through hole.
